(19) United States
(12) Patent Application Publication
(10) Pub. No.: US 2004/0036600 A1
(43) Pub. Date: Feb. 26, 2004

(54) Item tracking system

(76) Inventors: Tracey Lynch-Strozier, Aurora, IL (US); Roderic A. Strozier SR., Aurora, IL (US)

Correspondence Address: Michael S. Neustel, Suite No. 4, 2534 South University Drive, Fargo, ND, 58103, US

(21) Appl. No.: 10/227,493

(22) Filed: Aug. 22, 2002

(51) Int. Cl. G08B 1/08

(52) U.S. Cl. 340/539.13; 340/571; 340/539.32

(57) ABSTRACT

An item tracking system for efficiently locating various types of lost items. The item tracking system includes a transmitter unit and a receiver unit in communication with one another via radio signal. When a transmitter button upon the transmitter unit is depressed, the transmitter unit transmits a tracking signal that is received by the receiver unit, after which the receiver unit emits an audible sound to indicate the physical location of the item. The transmitter unit preferably is capable of transmitting a plurality of distinct tracking signals that correspond to a corresponding plurality of receiver units. The transmitter unit has an extended portion that includes an adhesive that allows for the non-movable attachment to an object. The receiver unit has a first band and a second band for snugly attaching to the item.

### CROSS REFERENCE TO RELATED DISCLOSURE DOCUMENT

The present application hereby references and incorporates by reference Disclosure Document No. 493,253 filed on Apr. 30, 2001.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to locating device and more specifically it relates to an item tracking system for efficiently locating various types of lost items.

2. Description of the Related Art

There are numerous devices currently commercially available that allow for the locating of remote controls, portable telephones and similar items. These devices operate by the user pushing a button upon a telephone station or television that sends a signal that is detected by the portable telephone or remote control thereafter emitting an audible sound to assist in locating the telephone or remote control. However, these devices are permanently built into the products and are not capable of being attached to various other items to locate. In addition, conventional locating technology that is commercially available does not allow for the control of multiple locating devices from a single station.

Examples of patented devices which are related to the present invention include U.S. Pat. No. 5,455,560 to Owen; U.S. Pat. No. 4,476,469 to Lander; U.S. Pat. No. 5,638,050 to Sacca; U.S. Pat. No. 5,337,041 to Friedman; U.S. Pat. No. 5,677,673 to Kipnis; U.S. Pat. No. 5,289,163 to Perez; U.S. Pat. No. 5,939,981 to Renney; and U.S. Patent 4,507,653 to Bayer.

While these devices may be suitable for the particular purpose to which they address, they are not as suitable for efficiently locating various types of lost items. Commercially available item locating technologies do not allow for the locating of various items with a single control station.

In these respects, the item tracking system according to the present invention substantially departs from the conventional concepts and designs of the prior art, and in so doing provides an apparatus primarily developed for the purpose of efficiently locating various types of lost items.

### BRIEF SUMMARY OF THE INVENTION

In view of the foregoing disadvantages inherent in the known types of locating devices now present in the prior art, the present invention provides a new item tracking system construction wherein the same can be utilized for efficiently locating various types of lost items.

The general purpose of the present invention, which will be described subsequently in greater detail, is to provide a new item tracking system that has many of the advantages of the item locating devices mentioned heretofore and many novel features that result in a new item tracking system which is not anticipated, rendered obvious, suggested, or even implied by any of the prior art locating devices, either alone or in any combination thereof.

To attain this, the present invention generally comprises a transmitter unit and a receiver unit in communication with one another via radio signal. When a transmitter button upon the transmitter unit is depressed, the transmitter unit transmits a tracking signal that is received by the receiver unit, after which the receiver unit emits an audible sound to indicate the physical location of the item. The transmitter unit preferably is capable of transmitting a plurality of distinct tracking signals that correspond to a corresponding plurality of receiver units. The transmitter unit has an extended portion that includes an adhesive that allows for the non-movable attachment to an object. The receiver unit has a first band and a second band for snugly attaching to the item.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an item tracking system that will overcome the shortcomings of the prior art devices.

A second object is to provide an item tracking system for efficiently locating various types of lost items.

Another object is to provide an item tracking system that may be utilized to locate various items including but not limited to keys, remote controls, telephones, adults, children, pets and other items.

An additional object is to provide an item tracking system that allows for the location of an item in darkened areas.

A further object is to provide an item tracking system that reduces the time required to locate an item.

Another object is to provide an item tracking system that communicates to an individual that another individual is searching for them.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the transmitter unit.

FIG. 2 is a side view of the transmitter unit.

FIG. 3 is an upper perspective view of the transmitter unit attached to a VCR.

FIG. 4 is an upper perspective view of the receiver unit.

FIG. 5 is a top view of the receiver unit.

FIG. 6 is an upper perspective view of the receiver unit attached to a remote control.

FIG. 7 is an upper perspective view of an alternative embodiment of the receiver unit for receiving keys.

### DETAILED DESCRIPTION OF THE INVENTION

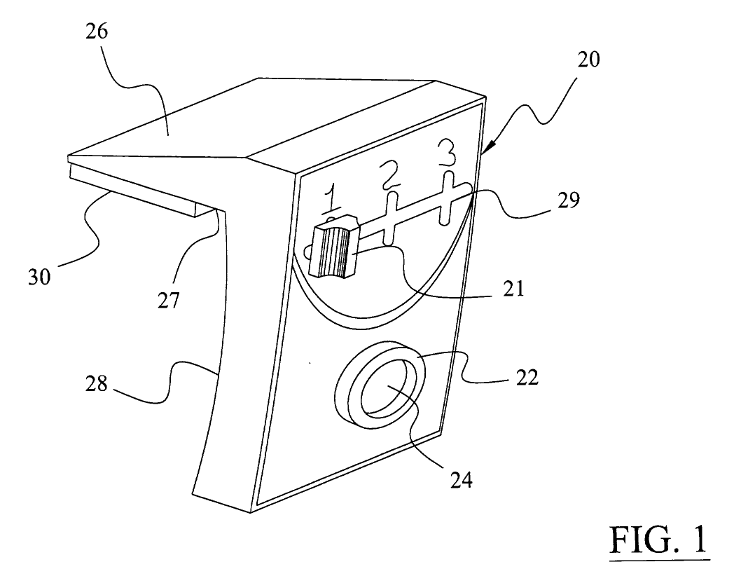

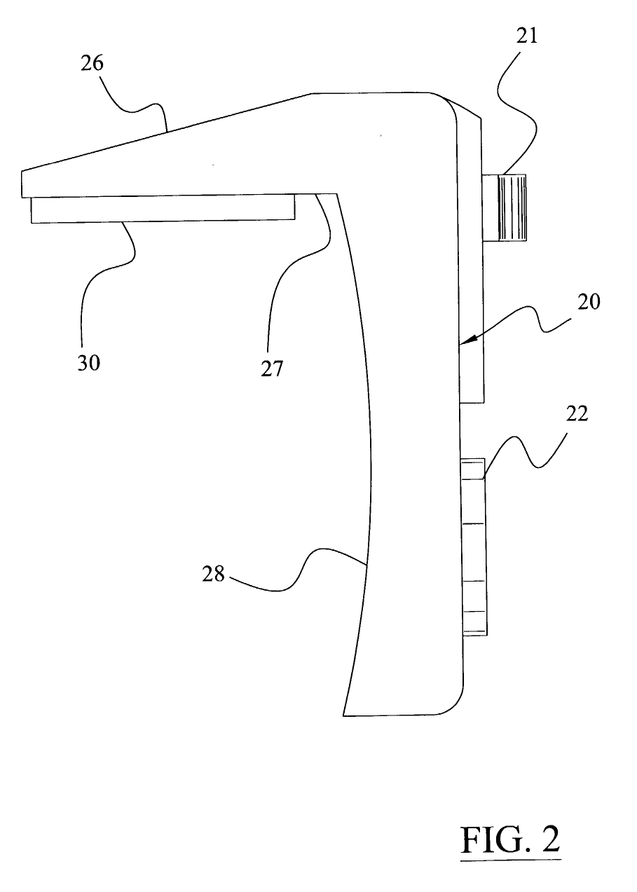

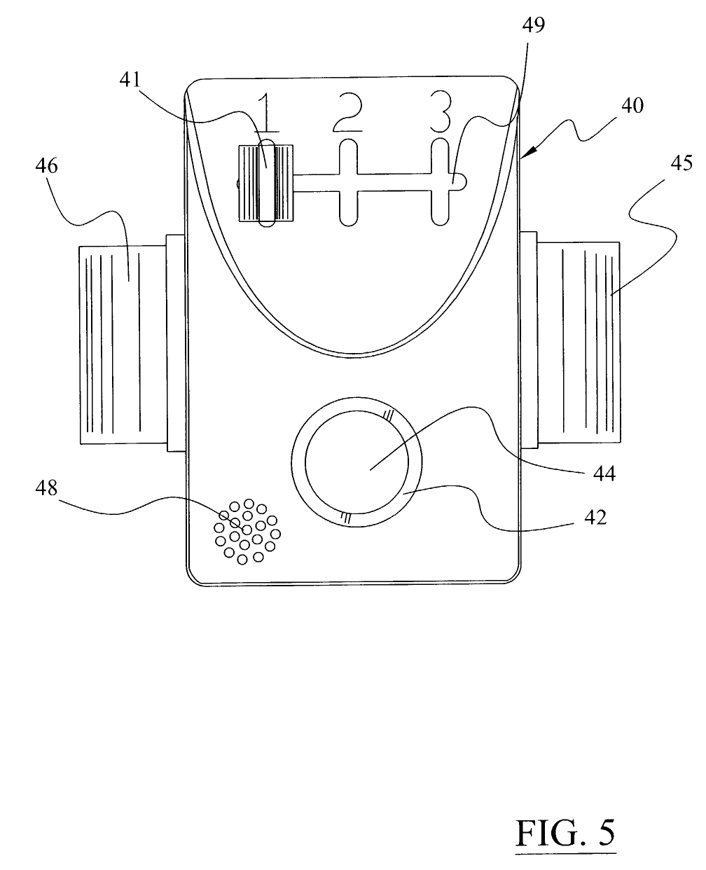

Turning now descriptively to the drawings, in which similar reference characters denote similar elements throughout the several views, FIGS. 1 through 7 illustrate an item tracking system 10, which comprises a transmitter unit 20 and a receiver unit 40 in communication with one another via radio signal. When a transmitter button upon the transmitter unit 20 is depressed, the transmitter unit 20 transmits a tracking signal that is received by the receiver unit 40, after which the receiver unit 40 emits an audible sound to indicate the physical location of the item 13. The transmitter unit 20 preferably is capable of transmitting a plurality of distinct tracking signals that correspond to a corresponding plurality of receiver units 40. The transmitter unit 20 has an extended portion 26 that includes an adhesive 30 that allows for the non-movable attachment to an object 12. The receiver unit 40 has a first band 45 and a second band 46 for snugly attaching to the item 13.

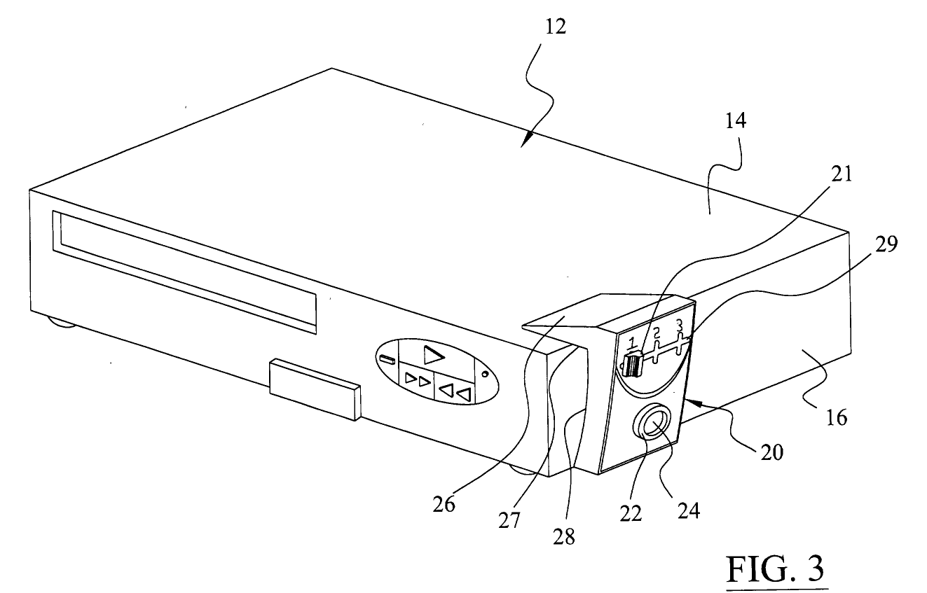

As shown in FIGS. 1 through 3 of the drawings, the transmitter unit 20 has an outer housing structure having an extended portion 26. The extended portion 26 extends a finite distance outwardly and has a lower surface 27. The lower surface 27 of the extended portion 26 preferably is substantially orthogonal with respect to an inner surface 28 of housing structure so as to be positioned upon an upper corner of an item 13 (upper surface 14 and side wall 16) such as a VCR, DVD player, cabinet or the like as shown in FIG. 3 of the drawings.

At least one piece of adhesive 30, hook and loop or other fastening material is preferably attached to the lower surface 27 for allowing non-movable attachment of the transmitter unit 20 to the item 13. The housing structure of the transmitter unit 20 may have various other configurations and structures other than illustrated in FIGS. 1 through 3 of the drawings.

The transmitter unit 20 includes a power source within that is electrically connected to a transmitter capable of transmitting a tracking signal. The transmitter may be comprised of any conventional transmitter technology utilized to transmit a unique radio signal. Various encoding may be included within the tracking signal which is commonly utilized within tracking signals.

It is desired that the tracking signal be detectable by the receiver unit 40 for a significant distance. A transmitter slot 29 within the housing structure allows for a transmitter control button 21 to control the desired frequency of the tracking signal in order to locate a specific receiver unit 40 preset to the same frequency. It can be appreciated that a varying number of tracking signals may be utilized with the transmitter unit 20 and receiver units 40 depending mainly upon the number of receiver units 40 utilized. Indicia are preferably positioned about the transmitter slot 29 for indicating the tracking signal that will be transmitted as shown in FIGS. 1 and 3 of the drawings.

A transmit button 24 is positioned within the housing structure of the transmitter unit 20 and electrically connected to the transmitter within the transmitter unit 20. When the transmit button 24 is depressed, the transmitter thereafter transmits the desired tracking signal as determined by the transmitter control button 21. A transmitter protective rim 22 extends from the housing structure of the transmitter unit 20 about the transmit button 24 for preventing accidental engagement of the transmit button 24.

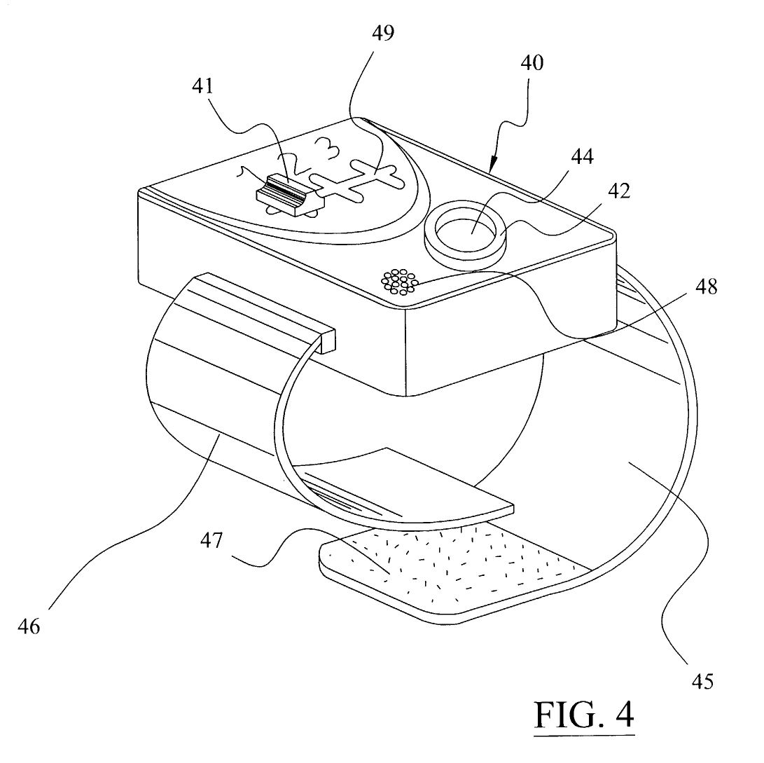

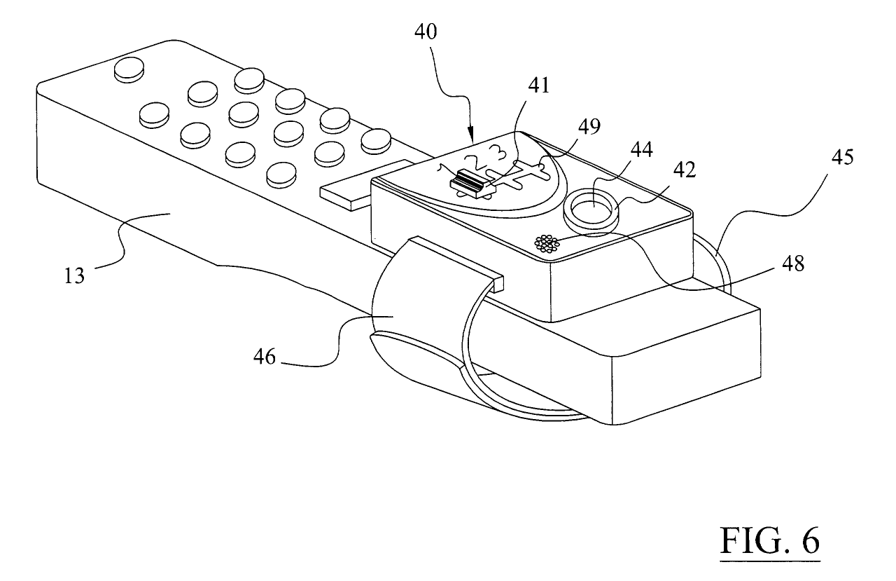

The receiver unit 40 is comprised of a housing structure which has at least one band extending from thereof for attaching to an item 13 such as a remote control. As shown in FIG. 4 of the drawings, the receiver unit 40 preferably includes a first band 45 and a second band 46 extending from opposing sides of the housing structure. A fastener 47 such as hook and loop fastener 47, buckle or other fastening device is attached to the distal portions of the bands 45, 46 for removably securing the bands 45, 46 together in a snug manner about the item 13 as shown in FIGS. 4 and 6 of the drawings. A single band may be utilized that forms a loop structure that is slipped over the item 13. The bands 45, 46 may be comprised of an elastic material for conforming to the overall structure of the item 13. The bands 45, 46 of the receiver unit 40 are preferably comprised of a photo luminescent material that provides a visual indication of the item 13 within darkened areas.

The receiver unit 40 includes a power source within that is electrically connected to a receiver capable of receiving, detecting and identifying a tracking signal transmitted by the transmitter unit 20. The receiver may be comprised of any conventional receiver technology utilized to receive/detect a unique radio signal. A speaker 48 is electronically connected to the receiver circuitry which emits an audible indicating sound that audibly indicates the location of the receiver unit 40 and the item 13.

A receiver slot 49 within the housing structure allows for a receiver control button 41 to control the desired tracking signal frequency to be detected by the receiver unit 40. Indicia are preferably positioned about the receiver slot 49 for indicating the tracking signal that will be detected from the transmitter unit 20 as shown in FIGS. 4 through 6 of the drawings.

A stop button 44 is positioned within the housing structure of the receiver unit 40 and electrically connected to the receiver circuitry within the receiver unit 40. If the speaker 48 is emitting the indicating sound, upon locating the item 13 the stop button 44 may be depressed which terminates the indicating sound. A receiver protective rim 42 extends from the housing structure of the receiver unit 40 about the stop button 44 for preventing accidental engagement of the stop button 44.

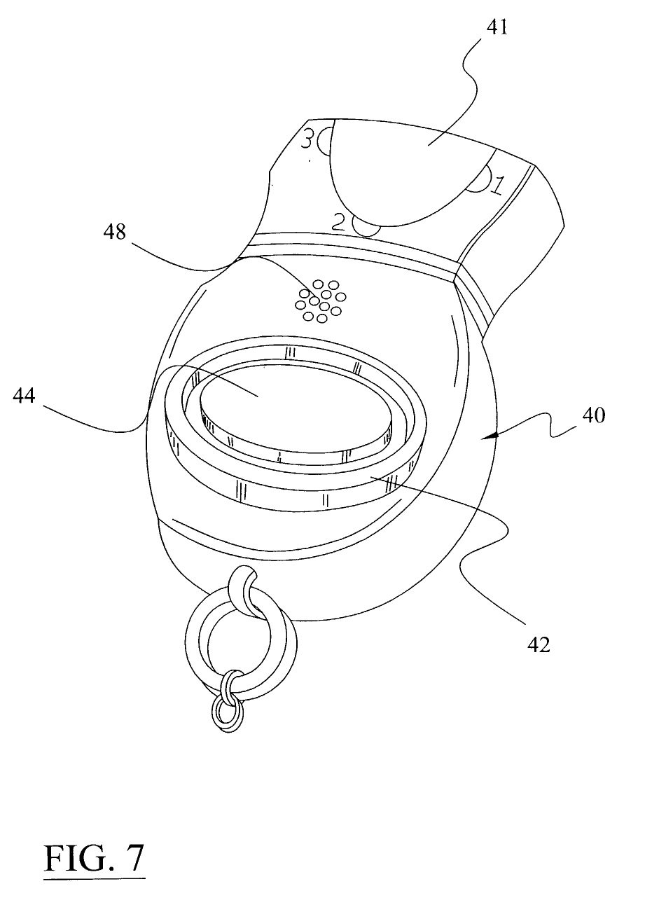

FIG. 7 illustrates an alternative embodiment of the receiver unit 40 which is capable of receiving a plurality of keys. A ring member 50 is preferably attached to the housing structure of the receiver unit 40 which receives the plurality of keys or other units. The receiver control button 41 is different from the button illustrate in FIGS. 4, 5 and 6 of the drawings, wherein the receiver control button 41 is rotated to the desired tracking signal instead of sliding.

In use, the user positions a first receiver unit 40 upon a first item 13, a second receiver unit 40 upon a second item 13 and so forth until the desired number of items 13 have a receiver unit 40 attached thereto. The user preferably attaches the receiver unit 40 upon the item 13 in a manner that does not interfere with the normal operation of the item 13 such as a remote control. The user then secures the transmitter unit 20 in a secure and visible object 12 such as upon a cabinet or VCR. When one of the items 13 is lost, the user simply adjusts the transmitter control button 21 to the desired tracking signal and then depresses the transmit button 24. For example, if the second item 13 is missing, the user will adjust the transmitter control button 21 to the number 2 position. The transmitter unit 20 thereafter transmits a second tracking signal which is detected by the appropriate receiver unit 40 preset to the number 2 position. The receiver unit 40 then emits an audible sound from the speaker 48 thereby audibly indicating the location of the receiver unit 40 and the item 13 attached thereto. If more than one receiver unit 40 is preset to the number 2 position, then all such receiver units 40 preset to the number 2 position will emit the audible sound. Once the item 13 is found by the user, the user then depresses the stop button 44 upon the receiver unit 40 which terminates the indicating sound emitted from the speaker 48.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. An item tracking system, comprising:
a transmitter unit capable of transmitting a tracking signal;
a receiver unit capable of receiving said tracking signal and emitting an audible sound upon receiving said tracking signal; and
at least one band attached to said receiver unit for securing to an item, wherein said at least one band is comprised of a photo luminescent material.

2. The item tracking system of claim 1, wherein said transmitter unit includes a transmitter control button for selecting a desired tracking signal.

3. The item tracking system of claim 2, wherein said receiver unit includes a receiver control button for selecting a desired tracking signal.

4. The item tracking system of claim 1, wherein said transmitter unit includes a transmit button surrounded by a transmitter protective rim.

5. The item tracking system of claim 1, wherein said receiver unit includes a stop button surrounded by a receiver protective rim, wherein said stop button terminates said audible sound.

6. The item tracking system of claim 1, wherein said at least one band is comprised of a first band, a second band and a fastener for selectively securing the first band to the second band.

7. The item tracking system of claim 6, wherein said first band and said second band are comprised of a flexible material.

8. The item tracking system of claim 6, wherein said first band and said second band are comprised of an elastic material.

9. The item tracking system of claim 1, wherein said receiver unit includes a receiver control button that is rotatably positioned within said receiver unit for selecting the desired tracking signal.

10. The item tracking system of claim 9, including a ring member attached to said receiver unit.

11. An item tracking system, comprising:
a transmitter unit having a housing structure and a transmitter within capable of transmitting a tracking signal;
wherein said housing structure includes an extended portion having a lower surface substantially orthogonal with respect to an inner surface of said housing structure;
a fastening device attached to said lower surface for securing the transmitter unit to an object;
a receiver unit capable of receiving said tracking signal and emitting an audible sound upon receiving said tracking signal; and
at least one band attached to said receiver unit for securing to an item, wherein said at least one band is comprised of a photo luminescent material.

12. The item tracking system of claim 11, wherein said transmitter unit includes a transmitter control button for selecting a desired tracking signal.

13. The item tracking system of claim 12, wherein said receiver unit includes a receiver control button for selecting a desired tracking signal.

14. The item tracking system of claim 11, wherein said transmitter unit includes a transmit button surrounded by a transmitter protective rim.

15. The item tracking system of claim 11, wherein said receiver unit includes a stop button surrounded by a receiver protective rim, wherein said stop button terminates said audible sound.

16. The item tracking system of claim 11, wherein said at least one band is comprised of a first band, a second band and a fastener for selectively securing the first band to the second band.

17. The item tracking system of claim 16, wherein said first band and said second band are comprised of a flexible material.

18. The item tracking system of claim 16, wherein said first band and said second band are comprised of an elastic material.

19. The item tracking system of claim 11, wherein said receiver unit includes a receiver control button that is rotatably positioned within said receiver unit for selecting the desired tracking signal.

20. The item tracking system of claim 19, including a ring member attached to said receiver unit.
